(19) United States
(12) Patent Application Publication
(10) Pub. No.: US 2023/0312926 A1
(43) Pub. Date: Oct. 5, 2023

(54) ULTRA-LOW VOLATILE ORGANIC COMPOUNDS SILICON RUBBER AND ITS MANUFACTURING METHOD

(71) Applicant: Estuen Inc., Siheung-si (KR)

(72) Inventor: Kui Hyun HWANG, Seoul (KR)

(73) Assignee: Estuen Inc., Siheung-si (KR)

(21) Appl. No.: 18/192,250

(22) Filed: Mar. 29, 2023

(30) Foreign Application Priority Data
Mar. 31, 2022 (KR) 10-2022-0040668

(51) Int. Cl. C08L 83/04

(52) U.S. Cl. CPC C08L 83/04

(57) ABSTRACT

The present invention relates to eco-friendly ultra-pure silicone in which volatile organic compounds (VOCs) are reduced to the extreme limit.

Embodiments of the present invention provide silicone rubber products that consumers can safely use. The silicone rubber product uses eco-friendly silicone rubber harmless to the human body with extremely reduced volatile organic compounds (VOCs) to 10 μg/g or less.

### CROSS-REFERENCE TO RELATED APPLICATION

This application claims priority to Korean Patent Application No. 10- 2022-0040668, filed on Mar. 31, 2022, the disclosure of which is incorporated by reference herein in its entirety.

### BACKGROUND OF THE INVENTION

1. Field of the Invention

The present invention relates to silicone rubber and, more specifically, to environmentally friendly ultra-pure silicone that minimizes volatile organic compounds (VOCs) to the extreme level.

2. Description of the Related Art

Volatile organic compounds (VOCs) are a general term for liquid or gaseous organic compounds with low boiling points that evaporate quickly into the atmosphere. They range from solvents commonly used in industrial settings to organic gasses emitted from chemical and pharmaceutical factories, plastic drying processes, and even everyday household items such as low-boiling liquid fuels, paraffin, olefins, and aromatic compounds.

VOCs can cause photochemical smog by reacting with nitrogen oxides (NOx) in the atmosphere to produce photochemical oxidants such as ozone. Substances such as benzene are carcinogenic and extremely harmful to human health, while most VOCs, including styrene, are classified as substances that cause unpleasant odors. Significant VOC sources include artificial sources such as facilities that use organic solvents, painting facilities, dry cleaning shops, gas stations, various means of transportation, and natural sources such as trees.

Silicone rubber also has excellent mechanical properties such as flexibility, strength, hardness, elongation, resilience, outstanding permanent compression set, and sound absorption rate. As a result, it is widely used in various infant products such as baby bottles, nipples, teething rings, tableware, as well as leisure and medical equipment. However, with the recent shift towards a necessary environmental trend beyond eco-friendliness, consumer standards for harmful chemicals in these products have increased. This trend includes not only the population of portable VOCs measuring devices and air purifiers for measuring and purifying VOCs emitted from furniture, paints, and household items but also meticulous inspection of materials and ingredients, including the emergence of a new term in the infant product market, “No-Chemi Mom,” which is a compound word of “No” and “Chemical.” This trend scrutinizes not only the price and design but also the materials and ingredients of products.

These harmful chemicals can be certified as environmentally friendly through certification such as the “Eco-Certification” mark, which the Korea. Environmental Industry and Technology Institute, a subsidiary of the Ministry of Environment, awards. The eco-certification mark is a nationally recognized certification mark that is only given to products that strictly manage harmful substances such as volatile organic compounds (VOCs), heavy metals, dimethylformamide (DMF), formaldehyde, phthalates, and alkylphenol ethoxylates (APEOs) which are suspected endocrine disruptors for infants. This certification process ensures that products meet strict environmental standards for the benefit of consumers.

However, despite the presence of green, eco, or organic labels, a product is only sometimes guaranteed to be environmentally friendly. Therefore, it can be difficult for the average consumer to choose a safe product among the countless options for baby products.

### SUMMARY OF THE INVENTION

The present invention is intended to provide silicone rubber and products utilizing it that can be used safely by reducing harmful volatile organic compounds (VOCs).

In addition, the present invention is intended to provide a safe silicone rubber product and products that do not detect fine silicone plastics, even with frequent cleaning and sterilization, by controlling the surface roughness of silicone.

The technical challenges to be achieved in the examples are not limited to the matters mentioned above, and other technical challenges not mentioned may be considered by those skilled in the art from various examples to be described below in the relevant technical field.

According to an embodiment of the present invention, the ultra-low VOCs silicone rubber has residual volatile organic compounds (VOCs) of 10 μg/g or less, and preferably, it can be 6.5 nig or less.

According to an embodiment of the present invention, an area having a pore structure with an average spacing between concave or convex portions on the surface of 200 to 500 nm can occupy an area ratio of 50% or more.

According to an embodiment of the present invention, the area ratio can be 80% or more. In addition, according to one embodiment of the present invention, the height difference between the bottom of the concave portion and the apex of the convex portion in the corrugated structure may be 300 nm or less.

According to an embodiment of the present invention, silicone rubber is a high-temperature vulcanizing silicone rubber, which can be a high-consistency rubber (HCR) or liquid silicone rubber (LSR).

According to an embodiment of the present invention, products for infants can be manufactured using ultra-low VOC silicone rubber. However, this is not limiting, and the invention can be applied to manufacturing food utensils, medical equipment, and other products that require reduced volatile organic compounds (VOCs) and safety.

According to the embodiments, the invention provides environmentally-friendly silicone rubber and products made thereof that minimize harmful chemical compounds such as volatile organic compounds (VOCs) to a level of 10 μg/g or less, which is safe for human use. This allows for producing silicone rubber-based products that consumers can confidently use, thereby providing a safe and reliable option.

In addition, by controlling the surface roughness of the silicone rubber, the present invention provides silicone rubber and products made from there that do not exhibit the detection of fine silicone plastics, even with frequent cleaning and disinfection.

The effects obtained from the examples are not limited to those mentioned above. Other effects not mentioned can be derived and understood by those skilled in the art based on the detailed descriptions below.

### DETAILED DESCRIPTION OF THE PREFERRED EMBODIMENTS

The following examples are embodiments combining the constituent elements and features thereof in a specified form. Each constituent element or feature may be considered optional unless explicitly mentioned separately. Each constituent element or feature may be implemented in a non-combined form with other constituent elements or features. Moreover, various embodiments may be formed by combining some constituent elements and/or features. The order of operations described in various embodiments may be altered. Some constituent elements or features of one embodiment may be included in another embodiment or replaced with corresponding constituent elements or features of another embodiment.

Throughout the specification, when a portion is said to “comprise” or “include” a specific constituent element unless expressly noted otherwise, it may include other constituent elements rather than excluding them. In addition, terms such as “part,” “unit,” “module,” and the like used in the specification refer to units that process at least one function or operation, which can be implemented by hardware, software, or a combination of hardware and software. Moreover, words such as “a,” “an,” “one,” “the,” and the like may be used to refer to both singular and plural meanings in the context of describing various embodiments unless otherwise indicated or refuted by the context of the claims below.

The present invention relates to silicone rubber, mainly used in fields requiring extreme reduction of volatile organic compounds (VOCs), and harmful chemicals included in it. The silicone rubber can be applied to general industrial or medical products requiring safety, such as infant products and food utensils. The suitable types of silicone rubber for this purpose may include high-temperature vulcanizing (HTV), high-consistency rubber (HCR), or liquid silicone rubber (LSR). However, as long as VOC reduction is required, it is not limited to the application or type of silicone rubber.

According to one embodiment of the present invention, the ultra-low VOC silicone rubber can have 10 μg/g or fewer VOCs. The inventors recognize that even silicone rubber that requires considerable safety may contain a small amount of VOCs. Using the supercritical carbon dioxide extraction method can minimize VOCs to the extreme.

A fluid in a supercritical state can be defined as a non-condensing high-density fluid that exceeds the critical temperature (Tc) and critical pressure (Pc), and a substance in this state is called a supercritical fluid. Even if the pressure is increased, a substance in a supercritical state does not become a liquid. It can be regarded as a high-density gas that does not liquefy, and a substance in a supercritical state is called a supercritical fluid. The density of a substance in a supercritical state is close to that of a liquid, and it can dissolve substances, and its viscosity is closer to that of a gas than a liquid. The diffusion coefficient within a supercritical fluid is intermediate between that of a liquid and a gas. Using these intermediate properties of liquids and gases makes it possible to change the properties by varying the temperature and pressure. It can be used for various purposes, such as extraction operations or solvents for chemical reactions.

Materials commonly used as supercritical fluids are water and carbon dioxide, which are non-toxic, non-flammable, and naturally occurring in the environment. In particular, carbon dioxide is mainly used for extraction and separation processes prone to thermal degradation due to its critical temperature (31° C.) being close to room temperature and its critical pressure (7.38 MPa) being easily manageable.

Supercritical carbon dioxide (SC-CO₂) becomes a supercritical fluid between liquid and gas at a temperature of 31° C. and a pressure of 1,070 psi. It is chemically inert, non-toxic, non-flammable, and polar, effectively dissolving fats and other non-polar substances. Additionally, it is quickly processed due to gas release under average temperature and pressure conditions, facilitating solvent removal and concentration.

In the present invention, supercritical carbon dioxide treatment is applied to injection-molded silicone rubber, reducing harmful chemical substances, including VOCs, to less than 10 μg/g and even lower to 6.5 μg/g.

Silicone rubber can be classified as room-temperature vulcanizing (RTV) silicone, which naturally cures at room temperature, and high-temperature vulcanizing (HTV) silicone, which requires heat to cure. HTV silicone rubber is further divided into high-consistency rubber (HCR) and liquid silicone rubber (LSR), depending on the degree of polymerization of the raw material used.

HCR is a solid silicone produced by injection molding using a press machine. It is a rubber made by compounding polyorganosiloxane as the main ingredient with silica-based reinforcing fillers and various additives to give it different properties, followed by curing by heating with a cross-linking agent. Compared to LSR, which will be discussed later, HCR has the disadvantage of high material loss and long cycle time due to its high viscosity. However, it is suitable for silicone sample production or small-scale production because of its low raw material input amount. Furthermore, it has excellent properties, including heat resistance, cold resistance, chemical resistance, and flame retardancy, which are not found in other organic rubber materials, making it widely used in various industries, such as automobiles, food, and leisure goods.

Liquid silicone rubber, which stands for LSR, is silicone in liquid form with low viscosity and good fluidity produced through injection molding, an automated process. LSR is suitable for mass production due to its low material loss and short cycle time in injection molding. It can be easily molded into complex molds, making it suitable for use in places requiring delicate designs and strict tolerances. In addition, LSR can be used in products requiring safety, such as children's-children's products, food utensils, and medical supplies, because it does not produce volatile oxidants or residues during the hardening process. However, even in the case of liquid silicone rubber, when analyzing the VOC content, it contains residual VOCs of approximately 35 to 55 μg/g (=ppmw).

Silicone rubber typically contains VOCs such as 2,2,4-trimethyl-pentane (CAS: 540-84-1), decamethyl-cyclopentasiloxane (CAS: 541-02-6), octamethyl-cyclotetrasiloxane (CAS: 556-67-2), dodecamethyl-cyclohexasiloxane (CAS: 540-97-6), tetradecamethyl-cycloheptasiloxane (CAS: 107-50-6), butylated hydroxytoluene (CAS: 128-37-0), hexadecamethyl-cyclooctasiloxane (CAS: 556-68-3), and octadecamethyl-cyclononasiloxane (CAS: 556-71-8), and even liquid silicone rubber (LSR), which is known as ultra-pure silicone, contains 2,2,4-trimethyl-3-carboxyisopropyi pentanoic acid isobutyl ester and/or nonadecane (CAS: 629-92-5), among others, that remains in the range of 35 to 55 μg/g.

However, in the present invention, it was found that the VOCs in silicone rubber that remains after superciitical carbon dioxide extraction can be reduced to less than 10 μg/g. Although VOCs such as butylated hydroxytoluene (CAS: 128-37-0) may remain and be detected after supercritical carbon dioxide extraction, it is evident that the total VOC content does not exceed 10 μg/g.

On the other hand, even silicone rubber products that are harmless to the human body may contain micro/nano plastics that can be detected due to repeated cleaning and steam sterilization. Microplastics and nano plastics refer to plastic particles that are smaller than 5 mm and 1 μm, respectively. Because of their small size, they flow into rivers and seas without being filtered out by sewage facilities and do not decompose naturally, becoming the main culprit in ecosystem destruction.

According to an embodiment of the present invention, silicone rubber can prevent the detachment of fine silicone plastic by controlling surface roughness during injection molding or pressing by applying supercritical carbon dioxide to a mold or press. The surface properties of the silicone rubber can be controlled by injecting supercritical carbon dioxide into the mold or press at a high temperature while curing the silicone rubber composition or before it is completely cured after being ejected from the mold or press. For example, supercritical carbon dioxide can be injected at a temperature range of 150 to 180° C. while maintaining a critical pressure (Pc) or higher.

To prevent the detachment of fine silicone plastic, it is practical to have a uniform and aesthetically pleasing surface with a fine protrusion structure on the surface of the silicone rubber. By controlling this protrusion structure, it is possible to reduce the initial residual volatile organic compounds (VOCs) and reduce the number of sites where chemical changes or foreign substances can be adsorbed during use. For this purpose, it is necessary to have an area with a fine protrusion structure with an average spacing of 200 to 500 nm on the surface of the silicone rubber and to control the area to a certain extent. In addition, to maintain a smooth surface of the silicone rubber for an extended period, it is preferable to widen the area with a fine protrusion structure.

According to an embodiment of the present invention, the silicone rubber can have an area ratio of 50%, or more of an area with a fine protrusion structure with an average spacing of 200 to 500 nm between concave or convex parts on the surface and, ideally can be 80% or more. Here, “protrusion structure” refers to the height difference of 100 nm or more between the bottom of a concave part and the vertex of an adjacent convex part.

The fine protrusion structure, as described above, can be evaluated using a scanning electron microscope (SENT). Although not limited to any particular model, for example, the number of fine protrusions or depressions crossing a certain distance can be measured and evaluated by dividing the measurement distance by the number.

The average spacing between concave or convex portions may be between 200 and 500 nm, but a more uniform range of 250 to 400 nm is desirable. An average spacing of less than 200 nm is difficult to control using supercritical carbon dioxide, and an average spacing of over 500 nm may result in a smoother surface. However, it may appear as visible bumps or spots. Furthermore, to prevent the detachment of fine silicone plastic within the above-average spacing range, it is desirable for the height difference between the bottom of the concave portion and the vertex of the convex portion of the filament structure to be less than 300 nm. if the height difference exceeds 300 nm, there is a risk that the convex portion may detach during cleaning and steam sterilization.

Hereafter, the present invention is further described in detail through the following specific examples. However, it should be understood that the present invention is more comprehensive than these examples.

### Example 1

Bulk-shaped injection molding was performed using KCC Silicon's SL7220 liquid silicone rubber (LSR). This silicone is used in nipples and teethers for baby products to enable surface observation. Supercritical carbon dioxide was not injected during the injection process and was treated with supercritical carbon dioxide after curing at room temperature.

### Example 2

Bulk-shaped injection molding was performed using KCC Silicon's SL7270 liquid silicone rubber (LSR), which is suitable for use in diving masks and other leisure products, in the same manner as Example 1. In addition, the mold was further covered during injection molding, and supercritical carbon dioxide was injected for production.

### Comparative Example 1

Bulk-shaped injection molding was performed using Silopren's LSR 4600 Series liquid silicone rubber, used in medical respirator masks, in the same manner as Example 1, but without supercritical carbon dioxide treatment.

### Comparison Example 2

A similar bulk form was press-injected using KCC Silicone's SH2630U medical HCE rubber used in medical hoses/parts.

### Comparison Example 3

A similar bulk form was press-injected using KCC Silicone's SH1460U HCE rubber, used. as a gasket for food sealing containers.

### Comparison Example 4

A similar bulk form was press-injected using KCC Silicone's SH5180U HCE rubber, which is used for kitchenware and other items in contact with food.

Measurement of Residual VOCs

TVOC (Total Volatile Organic Compounds) content was measured using the TD-GC/MS (Thermal desorption Gas chromatography/Mass spectrometry) analysis method for the silicone rubber samples of Examples 1, 2, and Comparative Examples 1 to 4, after heat treatment was performed at 100° C. for 20 minutes. The specific conditions of TD-GC/MS analysis were as follows:

### [Analysis Conditions]

Measurement instrument: MARKES TD100-xr Agilent Technologies 8890 GC, 5977B MSD Thermal Desorption pre-treatment conditions:
Heating temperature: 100° C.
Capture time: 20 minutes
GC/MS (Gas chromatography/Mass spectrometry)
Column: Agilent Technology Inc. HP-5MS
Cartier gas: Helium, 1.0 mL/min.
Analysis code: 12.2 m, 11.3 m, 10.3 m, 13.9 m, 16.3 m, 12.4 m

TABLE 1

| | Detection | | | | |
|---|---|---|---|---|---|
| | Time | | RMF | Content | TVOC |
| Division | (min) | Putative compounds on the GC-MS Library | (%) | (ppmw) | (μg/g) |
| Example 1 | 28.257 | Butylated Hydroxytoluene | 86.8 | 5.4 | 5.4 |
| Example 2 | 28.273 | Butylated Hydroxytoluene | 84.7 | 6.2 | 6.2 |
| Comparison | 23.678 | Cyclohexasiloxane, dodecamethyl- | 87.8 | 1.3 | 44.1 |
| Example 1 | 28.020 | Cycloheptasiloxane, | 85.5 | 3.1 | |
| | | tetradecamethyl- | | | |
| | 29.787 | Pentanoic acid, 2,2,4-trimethyl-3- | 86.6 | 16.4 | |
| | | carboxyisopropyl, isobutyl ester | | | |
| | 30.962 | Cyclooctasiloxane, hexadecamethyl- | 93.1 | 6.1 | |
| | 31.044 | Decane, 2,3,5,8-tetramethyl- | 76.4 | 3.5 | |
| | 31.366 | Nonadecane | 86.6 | 10.6 | |
| | 32.285 | 1,1,1,3,5,7,9,11,11,11-Decamethyl- | 82.5 | 3.0 | |
| | | 5- | | | |
| | | (trimethylsiloxy)hexasiloxane | | | |
| Comparison | 18.806 | Cyclopentasiloxane, decamethyl- | 86.9 | 1.5 | 77.6 |
| Example 2 | 23.669 | Cyclohexasiloxane, dodecamethyl- | 90.1 | 2.7 | |
| | 28.017 | Cycloheptasiloxane, | 86.8 | 5.6 | |
| | | tetradecamethyl- | | | |
| | 28.207 | Butylated Hydroxytoluene | 87.2 | 3.2 | |
| | 29.784 | Pentanoic acid, 2,2,4-trimethyl-3- | 84.9 | 32.4 | |
| | | carboxyisopropyl, isobutyl ester | | | |
| | 30.967 | Cyclooctasiloxane, hexadecamethyl- | 93.5 | 9.0 | |
| | 31.361 | Tetradecane, 2,6,10-trimethyl- | 80.5 | 14.9 | |
| | 32.292 | 1,1,1,3,5,7,9,11,11,11-Decamethyl- | 81.7 | 5.5 | |
| | | 5- | | | |
| | | (trimethylsiloxy)hexasiloxane | | | |
| | 33.066 | Cyclononasiloxane, | 87.3 | 2.8 | |
| | | octadecamethyl- | | | |
| Comparison | 18.801 | Cyclopentasiloxane, decamethyl- | 87.5 | 1.6 | 57.2 |
| Example 3 | 23.685 | Cyclohexasiloxane, dodecamethyl- | 92.4 | 3.6 | |
| | 28.033 | Cycloheptasiloxane, | 87.4 | 8.9 | |
| | | tetradecamethyl- | | | |
| | 28.210 | Butylated Hydroxytoluene | 86.4 | 2.4 | |
| | 29.798 | Pentanoic acid, 2,2,4-trimethyl-3- | 86.7 | 20.2 | |
| | | carboxyisopropyl, isobutyl ester | | | |
| | 30.884 | (7a-Isopropenyl-4,5- | 78.3 | 7.4 | |
| | | dimethyloctahydroinden-4- | | | |
| | | yl)methanol | | | |
| | 30.978 | Cyclooctasiloxane, hexadecamethyl- | 92.2 | 7.4 | |
| | 32.307 | Cyclooctasiloxane, hexadecamethyl- | 77.7 | 3.0 | |
| | 33.099 | Cyclononasiloxane, | 80.2 | 2.7 | |
| | | octadecamethyl- | | | |
| Comparison | 13.196 | Pentane, 2,2,4-trimethyl- | 88.4 | 1.1 | 61.3 |
| Example 4 | 18.805 | Cyclopentasiloxane, decamethyl- | 84.4 | 2.2 | |
| | 18.957 | Cyclotetrasiloxane, octamethyl- | 82.2 | 6.2 | |
| | 23.699 | Cyclohexasiloxane, dodecamethyl- | 93.7 | 4.7 | |
| | 28.043 | Cycloheptasiloxane, | 87.1 | 6.6 | |
| | | tetradecamethyl- | | | |
| | 28.215 | Butylated Hydroxytoluene | 79.9 | 2.4 | |
| | 29.812 | Pentanoic acid, 2,2,4-trimethyl-3- | 89.3 | 18.6 | |
| | | carboxyisopropyl, isobutyl ester | | | |
| | 30.932 | Cyclooctasiloxane, hexadecamethyl- | 80.6 | 6.9 | |
| | 32.278 | Cyclononasiloxane, | 66.9 | 9.7 | |
| | | octadecamethyl- | | | |
| | 33.043 | Cyclononasiloxane, | 84.3 | 2.7 | |
| | | octadecamethyl- | | | |

*RMF (reverse match factor): Spectral matching probability of a sample based on the spectrum
of the database

Referring to Table 1, Example 1 and 2, which were treated with supercritical carbon dioxide, exhibited a total VOCs content of less than 10 μg, which is approximately 10 times lower than the VOCs content range of 35 to 55 μg/g typically found in environmentally friendly liquid silicone rubbers (LSRs) commonly used. Various VOCs, including methyl cyclosiloxanes, were mainly removed, and only trace amounts of the safe butylated hydroxytoluene, used as an antioxidant in cosmetics and food, were detected. It was confirmed that the VOCs content of silicone rubber could be reduced to below 10 μg/g, below 8 μg/g, and even below 6.5 μg/g through treatment with supercritical carbon dioxide.

Comparative Example 1, which was not treated with supercritical carbon dioxide, exhibited a VOC content of 44.1 μg/g, considered safe for consumer markets.

Solid silicone rubbers in Comparative Examples 2 to 4 are safe silicone compositions used in medical and food applications. However, after curing, they exhibited VOCs contents of 77.6 μg/g, 57.2 μg/g, and 61.3 μg/g, respectively, within the range of 55 to 80 μg/g.

### Surface Observation and Detection Of Fine Silicone Plastic

Example 1, the silicone rubber was processed with supercritical carbon dioxide at room temperature after injection curing, and Example 2, which was manufactured by injecting supercritical carbon dioxide during the injection process, were compared with Reference Example 1 silicone rubber. The samples were cut into small sizes that were easy to observe, surface characteristics were observed, and experiments were conducted to detect fine silicone plastic exudation.

The average distance and height difference between convex parts on the surface was observed by scanning electron microscopy (SEM). The average distance was measured by dividing the distance by the number of convex bumps, and the surface structure area ratio of the image, taking into account the magnification, was calculated and evaluated.

The experiment to detect fine silicone plastic exudation was conducted by steaming each silicone rubber for 10 minutes, cooling it to room temperature (25° C.), washing it three times with purified water, and steaming it for another 10 minutes, and repeating the process 100 times. After that, microspectroscopy using optical hydrothermal infrared (O-PTIR) was used to observe the fine/nano silicone plastic fragments in purified water.

TABLE 2

| | surface appearance | | | |
|---|---|---|---|---|
| | | Concave- | Concave- | Micro |
| | Average | convex | convex structure | silicon |
| | Distance | structure | Height | plastic |
| Division | (nm) | area ratio (%) | Difference(nm) | detection |
| Example 1 | 420 | 45 | 380 | ◯ |
| Example 2 | 310 | 87 | 170 | |
| Comparison | 160 | 23 | 220 | ⊚ |

Example 1

Example 1's silicone rubber did not undergo supercritical carbon dioxide treatment during the injection process, resulting in a low VOC content but the inadequate formation of surface roughness structure. The average distance between convex portions was within the target range at 420 nm, but this could also be interpreted as being dependent on the composition of the silicone rubber and the quality of the mold, in addition to the supercritical fluid treatment. However, there were many cases where the ratio of diameter and height of convex portions was more significant than 1.0 due to a high height difference of 380 nm in the roughness structure, resulting in trace amounts of fine silicone plastic being detected within the range of 0.5 to 1.0 μm after 100 washings/sterilizations.

Example 2's silicone rubber contained a rough structure with an average distance of 310 μm between convex portions, with an area ratio of 85%, and no fine silicone plastic was detected. This could be attributed to a low height difference in the convex portions compared to the average distance, making it difficult for fine silicone plastic to be lost. Although the samples in this experiment were shaped to facilitate observation, when molded into products such as infant nipples with many folds, the area ratio of the roughness structure can be reduced to less than 80%. However, in areas that frequently come into contact with the human body and have no folds, it is necessary to maintain an area ratio of the roughness structure of at least 50%.

Comparative Example 1's1's silicone rubber was evaluated with an area ratio of less than 25%, making it difficult to consider the formation of a roughness structure. A large amount of fine silicone plastic was detected. This was judged to be due to a significant difference in height between the convex and concave portions compared to the average distance, making it easy for fine silicone plastic to be lost.

The various examples described can be embodied in other specific forms within the scope of the technical idea and essential features without departing from them. Therefore, the detailed description should not be interpreted restrictively in all respects but should be considered exemplary. A reasonable interpretation of the attached claims should determine the scope of the various examples. Any modification within the equivalent range of the various examples is included in the scope of the various examples. In addition, the examples may be constructed by combining claims not explicitly cited in the claims or may be included in new claims through amendment after filing.

What is claimed is:

1. An Ultra-low volatile organic compounds (VOCs) silicone rubber,
the ultra-low VOCs silicone rubber comprising less than 10 μg/g of VOCs.

2. The ultra-low VOCs silicone rubber according to claim 1,
wherein the ultra-low VOCs silicone rubber comprising 6.5 μg/g or less of VOCs,

3. The Ultra-low VOCs silicone rubber according to claim 1,
wherein the ultra-low VOCs silicone rubber has an area ratio of 50% or more in the surface of a concave-convex structure with an average spacing between concave or convex portions of the concave-convex structure is 200 to 500 nm.

4. The Ultra-low VOCs silicone rubber according to claim 3,
wherein the area ratio is 80% or more.

5. The Ultra-low VOCs silicone rubber according to claim 3,
wherein a height difference between a bottom of the concave portion and a top of the convex portion in the concave-convex structure is 300 nm or less.

6. The Ultra-low VOCs silicone rubber according to claim 1,
wherein the ultra-low VOCs silicone rubber is a high-temperature curing type, and
wherein the ultra-low VOCs silicone rubber is a solid silicone rubber or a liquid silicone rubber.

7. An article for a baby manufactured using the silicone rubber of claim 1.
